(19) United States
(12) Patent Application Publication
(10) Pub. No.: US 2017/0239978 A1
(43) Pub. Date: Aug. 24, 2017

(54) Form for Creating a Design on Grass and the Method of Creating the Design

(71) Applicant: Luis Avila Vera, New Albany, MS (US)

(72) Inventor: Luis Avila Vera, New Albany, MS (US)

(21) Appl. No.: 15/049,091

(22) Filed: Feb. 21, 2016

(51) Int. Cl. B44C 5/06; B44B 5/00

(52) U.S. Cl. CPC B44C 5/06; B44B 5/00

(57) ABSTRACT

A form to be used in creating a design in a yard and the method of installation of the design.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

Field of the invention

This disclosure relates to a form necessary for creating a raised design made of soil and sod installed in a yard and the method of creating the raised design in the yard.

### Background of the invention

Shaped bushes and trees cut to appear as recognizable characters, words, figures, or animals are common in the landscaping industry, and yards have been painted to place a temporary images on the grass.

However, the present disclosure presents a form necessary and the method of creating a raised design in a yard where the raised design is part of the yard, becomes a permanent feature of the yard, and said design is recognizable as a letter or letters, a logo, a character, figure, shape, or animal.

### SUMMARY OF THE INVENTION

The present disclosure reveals a form in the shape of the design to be incorporated in a yard wherein the shape of the form is of a letter, a logo, a character, figure, shape, or animal, such that when looking at the form the shape is apparent, wherein the form also possess a depth between the top edge of the form and a bottom edge of the form such that the depth of the form allows design that is to be incorporated into the yard to be built up and stand in relief above the surrounding yard but not so much so that when the form is removed from around the design, the design collapses. The form may have a tapered edge on a bottom edge of the form so that the form can be pressed into sod in order to cut the sod into the shape of the image that will be installed in the grass.

The form may also possess a latching mechanism such that, when the latching mechanism is closed the form is in the shape of the design to be installed in the grass and when the latching mechanism is opened the form can be removed from around the installed design. This embodiment may also comprise a tapered edge on a bottom edge of the form so that the form can be pressed into sod in order to cut the sod into the shape of the image that will be installed in the grass.

There may also be a plurality of anchoring stakes around the exterior of the form such that the anchoring stakes hold the form in-place while the design is constructed within the form. In this embodiment, there may be a latching mechanism such that, when the latching mechanism is closed the form is in the shape of the design to be installed in the grass and when the latching mechanism is opened the form can be removed from around the installed design. The bottom edge of the form may also be tapered so that the form can be pressed into sod in order to cut the sod into the shape of the image that will be installed in the grass.

The method of creating a design in a yard involves having a form in the shape of the design to be installed in the yard, next, shaping a collection of sod into the shape of the design of the form, followed by placing the form into the location of the yard where the design is to be installed, using a collection of soil to build up a base within the form, then installing the shaped collection of sod onto the base within the form and finally, removing the form.

### BRIEF DESCRIPTION OF THE SEVERAL VIEWS OF THE DRAWING

FIG. 1 is a view of a form indicating the design to be installed in a yard as well as the depth of the form and a tapered edge;

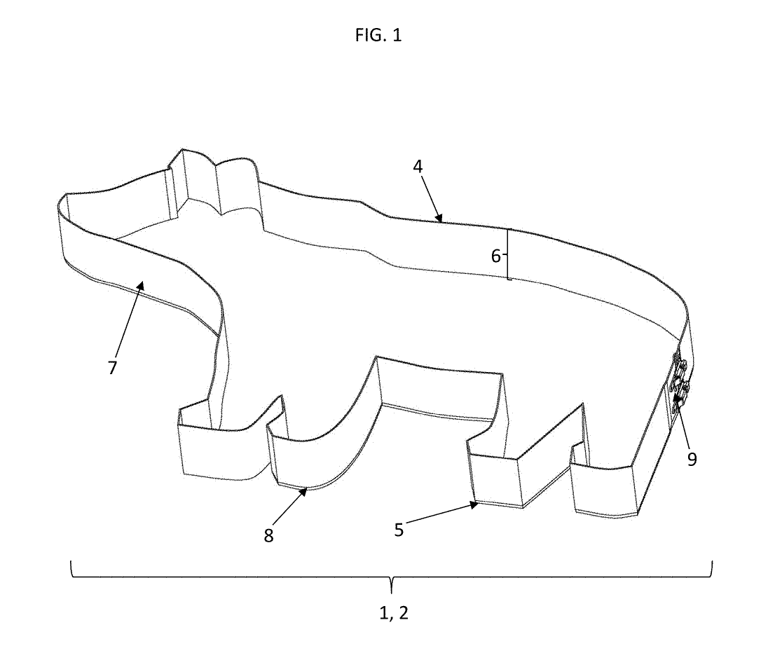

FIG. 2 is a view of the form with a latching mechanism;

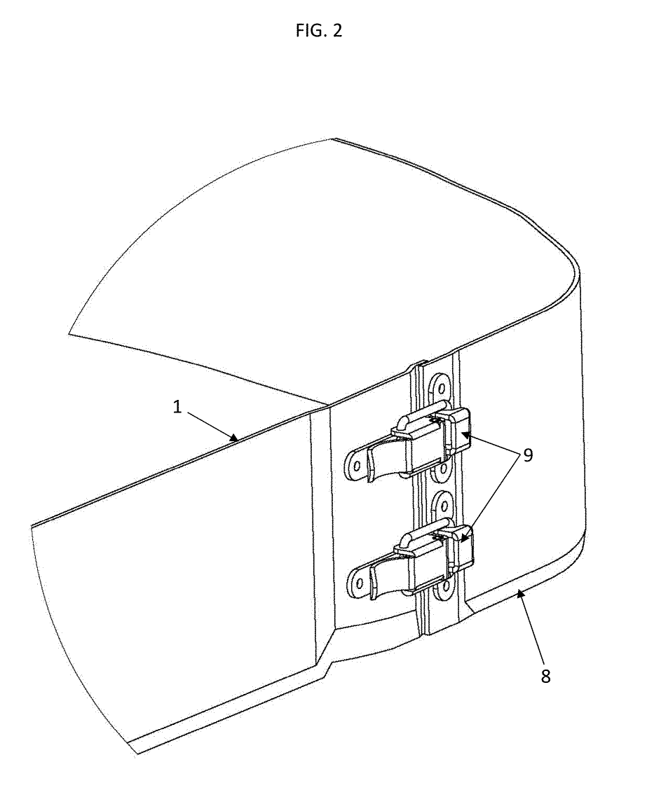

FIG. 3 is a view of the form in place in a yard, also indicating a plurality of anchoring stakes;

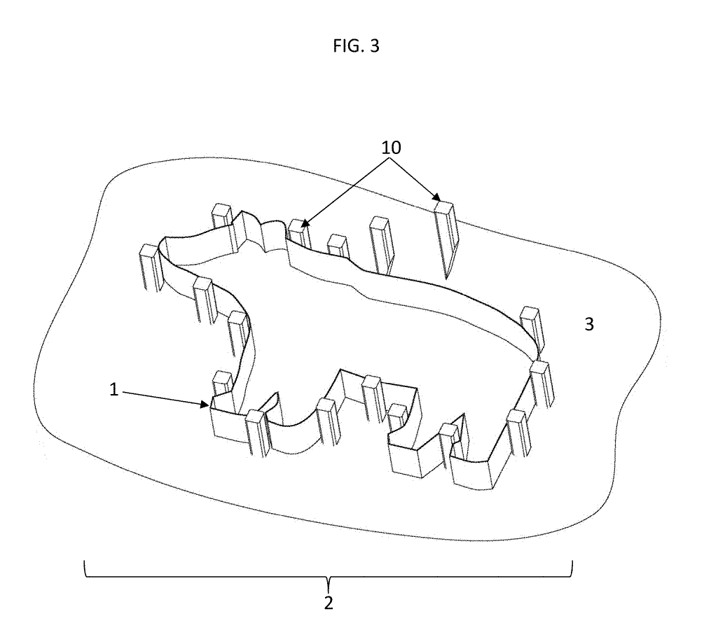

FIG. 4 is a pictorial progression of the steps for the method of installation of the design in to a yard including cutting of sod, placing the form, building the base from soil, and inserting the cut sod into the form; and

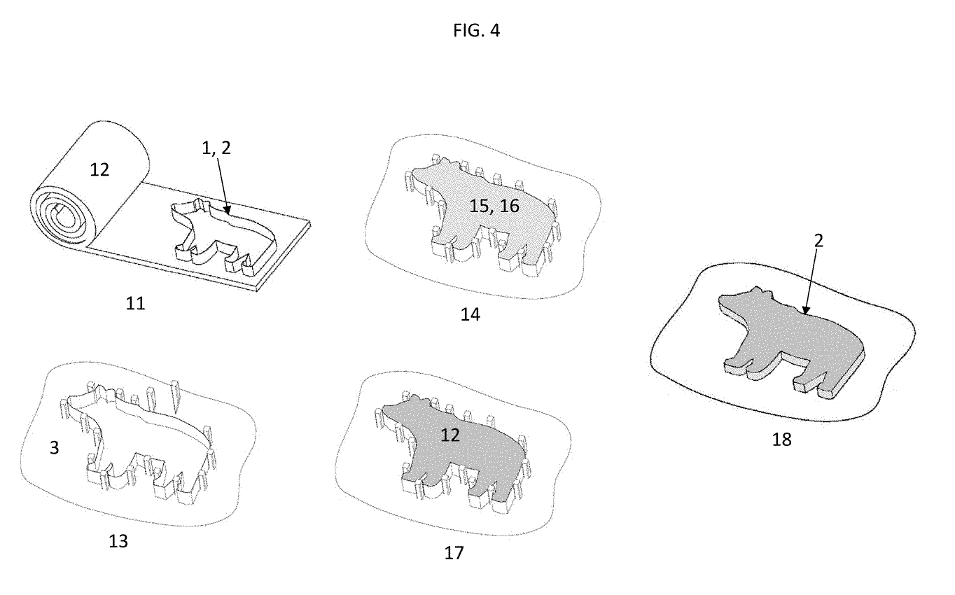

FIG. 5 is a representation of the finished design installed in a yard.

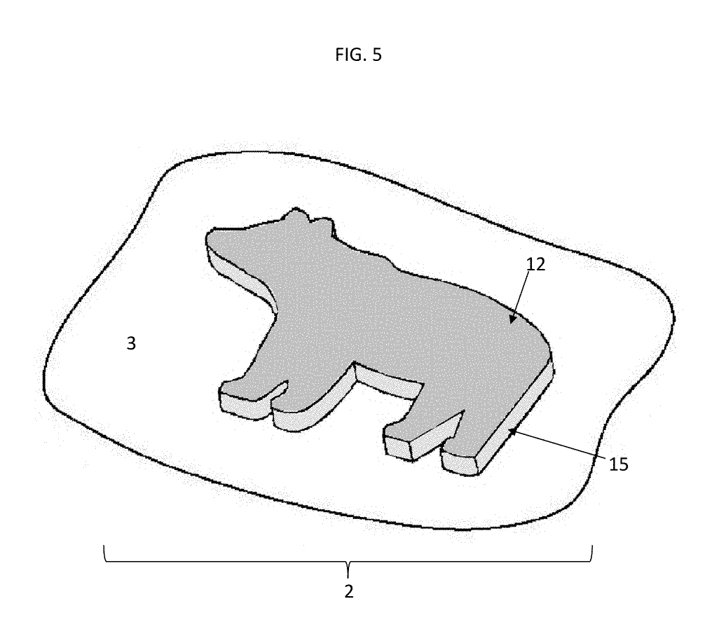

### DETAILED DESCRIPTION OF THE INVENTION

The present disclosure reveals a form 1 used for creating a design 2 in a yard 3 wherein the form 1 is in the shape of the design 2 to be installed in a yard 3, and the form 1 comprises a top edge 4, a bottom edge 5, a depth 6 between the top edge 4 and the bottom edge 5, and an exterior 7.

In the first embodiment of the form the bottom edge 5 of the form 1 may be tapered 8.

In the second embodiment of the form 1 the form 1 has a latching mechanism 9 on the exterior 7 of the form 1 that allows the design 2 of the form 1 to be opened or closed. In this embodiment, the bottom edge 5 of the form 1 may be tapered 8.

In the third embodiment of the form 1 there is a plurality of anchoring stakes 10 around the exterior 7 of the form 1 to secure the form 1 in place in the yard 3 during the creation of the design 2. In this embodiment, the bottom edge 5 of the form 1 may be tapered 8. This embodiment may also possess a latching mechanism 9 on the exterior 7 of the form 1 that allows the design 2 of the form 1 to be opened or closed.

In the method of creating a design 2 in a yard 3, the form 1 is in the shape of the design 2 to be installed. First then 11, a collection of sod 12 is shaped into the design 2 of the form 1, where the sod 12 is placed into the form 1 to ensure complete coverage of sod 12 in the design 2. Second 13, the form 1 is placed into the location of the yard 3 where the design 2 is to be installed. Third 14, a collection of soil 15 is used to build up a base 16 within the form 1 upon which the design 2 shall be installed, wherein the collection of soil 15 may comprise soil, sediment, aggregate material or a preformed material. Fourth 17, the cut sod 12 in the shape of the design 2 is inserted onto the base 16 within the form 1. Fifth 18, the form 1 is removed.

What is claimed:

1. A form for creating a design in a yard comprising:
the form in the shape of the design to be installed in a yard, with a top edge, a bottom edge, a depth between the top edge and the bottom edge, and an exterior of the form.

2. The form of claim 1 wherein the bottom edge of the form is tapered.

3. The form of claim 1 wherein the form has a latching mechanism on the exterior of the form that allows the form to be opened or closed.

4. The form of claim 3 wherein the bottom edge of the form is tapered.

5. The form of claim 1 wherein the form has a plurality of anchoring stakes around the exterior of the form to secure the form in place in the yard.

6. The form of claim 1 wherein the bottom edge of the form is tapered.

7. The form of claim 1 wherein the form has a plurality of anchoring stakes around the exterior of the form to secure the form in place in the yard.

8. The form of claim 7 wherein the form has a latching mechanism on the exterior of the form that allows the form to be opened or closed.

9. The form of claim 8 wherein the top edge of the form is tapered.

10. A method of creating a design in a yard with the use of a form in the shape of the design comprising:
first, shaping a collection of sod into the shape of the design of the form, where the sod is placed into the form to ensure complete coverage of sod in the design;
second, placing the form into the location of the yard where the design is to be installed;
third, using a collection of soil to build up a base within the form upon which the design shall be installed;
fourth, installing the shaped collection of sod onto the base within the form; and
fifth, removing the form.
